(19) United States
(12) Patent Application Publication
(10) Pub. No.: US 2026/0209137 A1
(43) Pub. Date: Jul. 23, 2026

(54) A Carbon-Fixing and Nitrogen-Retaining Bio-Organic Fertilizer and Its Preparation Method

(71) Applicant: Institute of Environment and Sustainable Development in Agriculture, CAAS, Beijing (CN)

(72) Inventors: Qingwen ZHANG, Beijing (CN); Yulong SHI, Beijing (CN)

(73) Assignee: Institute of Environment and Sustainable Development in Agriculture, CAAS, Beijing (CN)

(21) Appl. No.: 19/294,236

(22) Filed: Aug. 7, 2025

(30) Foreign Application Priority Data
Jan. 23, 2025 (CN) 2025101101667

(51) Int. Cl. C05F 17/20; C05F 3/00

(52) U.S. Cl. CPC C05F 17/20; C05F 3/00

(57) ABSTRACT

The present invention relates to the field of biological fertilizer technology. Specifically, it provides a Carbon-Fixing and nitrogen-retaining bio-organic fertilizer and its preparation method. The invention involves loading molybdenum, copper, cobalt, and a compound microbial consortium onto biochar to prepare loaded biochar. This loaded charcoal is then combined with perilla biomass extract and animal manure to form the bio-organic fertilizer. The fertilizer avoids unnecessary waste of microbial resources, significantly promotes soil retention of ammonium and nitrate nitrogen, accelerates organic matter decomposition and nutrient availability through the compound microbial consortium, so as to improve soil productivity. Additionally, the fertilizer enhances soil enzyme activity, promotes soil fertility, and ultimately achieves soil conditioning effects.

### TECHNICAL FIELD

The present invention relates to the technical field of biological fertilizers, specifically to a Carbon-Fixing and nitrogen-retaining bio-organic fertilizer and its preparation method.

### BACKGROUND

The excessive use of chemical fertilizers and unsustainable agricultural practices have long disrupted soil carbon-nitrogen cycles balance. The excessive us of chemical fertilizers has led to large scale soil and underground water pollution, reduced crop quality, and increased greenhouse gas emissions. With the increasing attention to food safety and the ecological environment, green food and organic agriculture have achieved rapid development.

Bio-organic fertilizer is a fertilizer compounded from specific functional microorganisms and harmlessly treated livestock manure, crop straws, and decomposed organic materials, which has the dual effects of microbial fertilizers and organic fertilizer efficiency. Bio-organic fertilizers are rich in organic carbon. Applying bio-organic fertilizers can increase the input of organic carbon in the soil, promote the accumulation of soil organic carbon, and improve the soil's carbon fixation capacity. By optimizing the returning method of straw and animal organic fertilizers to field, reducing the content of easy-to-decompose carbon in organic materials, and increasing the content of difficult-to-decompose carbon, methane emissions can be effectively controlled, and the soil's carbon fixation effect can be improved. The nitrogen in bio-organic fertilizers mainly exists in an organic form. After being applied to the soil, it is gradually released through the decomposition of microorganisms, which can provide a continuous and stable nitrogen supply for crops and reduce nitrogen loss.

However, the nutrient content of existing bio-organic fertilizers is relatively low, and the nutrient release rate and utilization rate are not ideal. Therefore, it is an urgent practical need to further increase the nutrient content in bio-organic fertilizers to better meet the growth needs of crops. The carbon fixation efficiency of existing bio-organic fertilizers is not high. Screening and cultivating more efficient carbon sequestration and nitrogen preservation microbial strains, adding them to bio-organic fertilizers, and increasing the microbial activity and population in the soil, and thereby improving the carbon sequestration and nitrogen preservation capacity of bio-organic fertilizers are important development directions in the technical field of bio-fertilizers.

### SUMMARY

Aiming at the technical problems existing in the prior art, the purpose of the present invention is to provide a bio-organic fertilizer for carbon sequestration and nitrogen retention and its preparation method.

The purpose of the this invention can be realized through the following technical solutions: The present invention provides a preparation method of a bio-organic fertilizer for carbon sequestration and nitrogen preservation, comprising the following steps:
(1) Crush corn straw and polyvinyl alcohol resin by weight parts, mixing uniformly with a solution containing potassium carbonate and potassium hydroxide, dry it, and place the dried mixture in a carbonization furnace to carbonize under a nitrogen atmosphere to obtain activated biochar;
(2) Immerse the activated biochar prepared in step (1) in a mixed solution containing H₂O₂ and cobalt(II) ethylenediaminetetraacetate (Co-EDTA), stir for 2-4 hours, and grind to obtain a hierarchical porous structure product;
(3) Mix the hierarchical porous structure product prepared in step (2) with a composite microbial consortium, and stir for 1 hour to obtain the modified biochar; the composite microbial consortium is obtained by mixing Azotobacter chroococcum, Pantoea ananatis, and Aspergillus niger solution, wherein the mass ratio of Azotobacter chroococcum:Pantoea ananatis:Aspergillus niger is 2:1:1, and the total mass of the microbial strains in the composite microbial consortium constitutes 2% of the mass of the hierarchical porous structure product prepared in step (2).
(4) Immerse the modified biochar prepared in step (3) in a mixed solution containing tetraamminecopper(II) sulfate and Mo-EDTA complex, stirring for 1-2 hours to obtain the loaded biochar;
(5) Fully mix the loaded biochar, perilla biomass extract, and animal manure, stir the mixture for 20-30 minutes, and concentrate it to obtain the carbon fixing and nitrogen retaining bio-organic fertilizer.

Further, in step (1), the mass ratio of corn straw to polyvinyl alcohol resin is 100:(1-10), and the carbonization temperature is 700-800° C.

Further, in step (2), the mass ratio of the activated biochar to cobalt(II) ethylenediaminetetraacetate in the mixed solution is 1:(0.01-0.2), and the stirring time is 2 hours.

Further, in step (3), the mass ratio of Azotobacter chroococcum, Pantoea ananatis, and Aspergillus niger is 2:(1-2):(1-2), and the total mass of the strains in the compound microbial consortium constitutes 2-30% of the mass of the hierarchical porous structure product prepared in step (2).

Further, in step (5), the preparation method of the perilla biomass extract comprises: adding perilla to water, stirring for 10 minutes, heat-treating the obtained juice for 2-3 hours at a heat-treatment temperature of 80-120° C. to obtain the perilla biomass extract.

Further, 5-60 grams of perilla are added to each 1 L of water for the juice.

Further, in step (4), the mass ratio of the modified biochar, tetraamminecopper(II) sulfate, and Mo-EDTA complex is 1:(0.05-0.2):(0.05-0.2).

Further, in step (5), the mass ratio of the loaded biochar, perilla biomass extract, and animal manure is 1:(10-100):(10-100).

The present invention selects potassium hydroxide and potassium carbonate as activators to activate corn straw and polyvinyl alcohol resin rich in oxygen-containing functional groups to prepare activated biochar. Compared with other conventional activators such as sodium hydroxide, the joint activation of corn straw and polyvinyl alcohol resin by potassium hydroxide and potassium carbonate is more conducive to the loading of strains in the compound microbial consortium on the biochar, improves the utilization efficiency of strains, and further improves the carbon sequestration and nitrogen preservation capacity of the finally prepared organic fertilizer. The synergistic activation of the biomass system composed of straw and polyvinyl alcohol resin by potassium hydroxide and potassium carbonate can prepare the biochar with a hierarchical pore structure, in which the proportion of macropores is greater, ensuring the high loading rate of subsequent strains on the surface of the biochar. An appropriate amount of metal cobalt complex, metal molybdenum and copper complex, and strains are all loaded in the corresponding pore structures, which further improves the pore utilization efficiency in the biochar.

In the preparation process of the present invention, the complex microbial community is first loaded onto the biochar, and then the metal molybdenum and copper complexes are loaded. Since the molecular size of the metal molybdenum and copper complexes is much smaller than the strains in the compound microbial consortium, the complexes are combined with the active sites formed by each strain on the biochar, fully utilizing the active sites on the biochar, improving the utilization efficiency of the active sites in the biochar, and at the same time ensuring the loading efficiency of the strains in the compound microbial consortium.

The present invention uses Azotobacter chroococcum, Pantoea ananatis, and Aspergillus niger as the composite microbial consortium, which not only exhibits synergistic effects between free-living nitrogen-fixing microbes and decomposing microbes, where the strains mutually provide energy substances, but also suggests that intermediate products of certain strains may facilitate the decomposition or nitrogen fixation of other strains. Compared with composite microbes formed by other strain combinations, the consortium described in this invention enables the organic fertilizer to have better fertility, accelerate the nitrogen fixation process, and improve nitrogen fixation efficiency.

The present invention uses cobalt(II) ethylenediaminetetraacetate, tetraamminecopper(II) sulfate, and Mo-EDTA complex as the precursors of the metal components. Compared with the metal inorganic salt components, it can ensure the low salinity of the organic fertilizer, thereby avoiding the high mortality rate of beneficial soil microbes. At the same time, the selection of Mo-EDTA complex can be used to provide a high level of molybdenum to the surface of the biochar in a stable liquid preparation.

The present invention uses perilla as the raw material for the biomass extract. First, perilla can be obtained in large quantities without special cultivation. At the same time, perilla has a high nitrogen content. Compared with other plants, the nitrogen can have a high nitrogen recovery rate through the preparation of the biomass extract, and then be introduced into the soil through the organic fertilizer of the present invention.

The present invention also provides a carbon sequestration and nitrogen preservation bio-organic fertilizer prepared by the preparation method.

### The Beneficial Effects of the Present Invention

1. In the invention, molybdenum, copper, cobalt, and a complex microbial community are loaded onto biochar. The prepared organic fertilizer can avoid unnecessary waste of microbial resources, and the organic fertilizer can significantly promote the soil's retention of ammonium nitrogen and nitrate nitrogen.
2. The present invention discovers that using Azotobacter chroococcum, Pantoea ananatis, and Aspergillus niger as the composite microbial consortium not only exhibits synergistic effects between free-living nitrogen-fixing microbes and decomposing microbes, where the strains mutually provide energy substances, but also suggests that intermediate products of certain strains may facilitate the decomposition or nitrogen fixation of other strains. Compared with composite microbes formed by other strain combinations, the consortium described in this invention enables the organic fertilizer to have better fertility, accelerate the nitrogen fixation process, and improve nitrogen fixation efficiency.
3. The present invention uses corn straw, together with polyvinyl alcohol resin, as biomass raw materials to prepare biochar. After activation by potassium hydroxide and potassium carbonate, biochar with a three-dimensional cross-linked structure can be prepared. The biochar forms a large number of small chambers, which loads the complex microbial community after oxidation, and these complex microbial communities multiply in large numbers with the help of the heat preservation and moisture preservation effects brought by the small chambers, thereby promoting the improvement of the fertility of the organic fertilizer.
4. The organic fertilizer in the present invention can increase the soil organic matter and nitrogen content, adjust the pH value. The compound microbial consortium can promote the decomposition of organic matter and the availability of nutrients, and be conducive to the improvement of soil productivity. At the same time, the organic fertilizer can significantly improve soil enzyme activity, promote the improvement of soil fertility, and finally achieve the role of soil conditioning.

### THE DETAILED DESCRIPTION OF THE EMBODIMENTS

The technical solutions in the embodiments of the present invention will be clearly and completely described below in conjunction with the embodiments of the present invention. Obviously, the described embodiments are only part of the embodiments of the present invention, not all of them. All other embodiments obtained by those of ordinary skill in the art without creative efforts based on the embodiments of the present invention belong to the protection scope of the present invention.

Unless otherwise specified, the raw materials and equipment used in the embodiments of the present invention are conventional raw materials and equipment in the technical field. The endpoints and any values of the ranges disclosed herein are not limited to the precise ranges or values, and these ranges or values should be understood to include values close to these ranges or values. For numerical ranges, the endpoints of each range, the endpoints of each range and individual point values, and individual point values can be combined with each other to obtain one or more new numerical ranges, which should be considered as specifically disclosed in this article.

### Embodiment 1

A carbon fixing and nitrogen retaining bio-organic fertilizer, prepared by the following preparation method:
(1) Weigh corn stalks and polyvinyl alcohol resin at a mass ratio of 100:1. After crushing the corn stalks and polyvinyl alcohol resin, uniformly mix them with a solution containing potassium carbonate and potassium hydroxide, dry the mixture, place the dried mixture in a carbonization furnace, and conduct carbonization at 700° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.01. Stir the mixture for 2 hours, and grind it to obtain a hierarchical porous structure product;
(3) Mix the hierarchical porous structure product prepared in step (2) with a compound microbial consortium, stir the mixture for 1 hour to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1:1, and the total mass of the strains in the compound microbial consortium constitutes 2% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.05:0.05, stir the mixture for 1 hour to obtain loaded biochar;
(5) Fully mix the loaded biochar, perilla biomass extract, and animal manure. The mass ratio of the loaded biochar, perilla biomass extract, and animal manure is 1:20:80. Stir the mixture for 20 minutes, and concentrate it to obtain the carbon fixing and nitrogen retaining bio-organic fertilizer.

The preparation method of the perilla biomass extract includes: adding 5 g of perilla to 1 L of water, stirring for 10 minutes, heat-treating the obtained juice for 2 hours at a heat-treatment temperature of 80° C. to obtain the perilla biomass extract.

### Embodiment 2

A carbon fixing and nitrogen retaining bio-organic fertilizer, prepared by the following method:
(1) Weigh corn stalks and polyvinyl alcohol resin at a mass ratio of 100:3. After crushing the corn stalks and polyvinyl alcohol resin, uniformly mix them with a solution containing potassium carbonate and potassium hydroxide, dry the mixture, place the dried mixture in a carbonization furnace, and conduct carbonization at 730° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.05. Stir the mixture for 2 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.2:1.2, and the total mass of the strains in the compound microbial consortium is 10% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.08:0.08, stir the mixture for 1 hour to obtain loaded biochar;
(5) Fully mix the loaded biochar, perilla biomass extract, and animal manure. The mass ratio of the loaded biochar, perilla biomass extract, and animal manure is 1:30:70. Stir the mixture for 25 minutes, and concentrate it to obtain the carbon fixing and nitrogen retaining bio-organic fertilizer.

The preparation method of the perilla biomass extract includes: adding 10 g of perilla to 1 L of water, stirring for 10 minutes, heat-treating the obtained juice for 2.5 hours at a heat-treatment temperature of 90° C. to obtain the perilla biomass extract.

### Embodiment 3

A carbon fixing and nitrogen retaining bio-organic fertilizer, prepared by the following method:
(1) Weigh corn stalks and polyvinyl alcohol resin at a mass ratio of 100:5. After crushing the corn stalks and polyvinyl alcohol resin, uniformly mix them with a solution containing potassium carbonate and potassium hydroxide, dry the mixture, place the dried mixture in a carbonization furnace, and conduct carbonization at 750° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.08. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.5:1.5, and the total mass of the strains in the compound microbial consortium constitutes 15% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.1:0.1, stir the mixture for 1.5 hours to obtain loaded biochar;
(5) Fully mix the loaded biochar, perilla biomass extract, and animal manure. The mass ratio of the loaded biochar, perilla biomass extract, and animal manure is 1:40:60. Stir the mixture for 25 minutes, and concentrate it to obtain the carbon fixing and nitrogen retaining bio-organic fertilizer.

The preparation method of the perilla biomass extract includes: adding 30 g of perilla to 1 L of water, stirring for 10 minutes, heat-treating the obtained juice for 2.5 hours at a heat-treatment temperature of 90° C. to obtain the perilla biomass extract.

### Embodiment 4

A carbon fixing and nitrogen retaining bio-organic fertilizer, prepared by the following method:
(1) Weigh corn stalks and polyvinyl alcohol resin at a mass ratio of 100:7. After crushing the corn stalks and polyvinyl alcohol resin, uniformly mix them with a solution containing potassium carbonate and potassium hydroxide, dry the mixture, place the dried mixture in a carbonization furnace, and conduct carbonization at 760° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.1. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.7:1.7, and the total mass of the strains in the compound microbial consortium constitutes 20% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.15:0.15, stir the mixture for 2 hours to obtain loaded biochar;
(5) Fully mix the loaded biochar, perilla biomass extract, and animal manure. The mass ratio of the loaded biochar, perilla biomass extract, and animal manure is 1:30:60. Stir the mixture for 30 minutes, and concentrate it to obtain the carbon fixing and nitrogen retaining bio-organic fertilizer.

The preparation method of the perilla biomass extract includes: adding 40 g of perilla to 1 L of water, stirring for 10 minutes, heat-treating the obtained juice for 2.5 hours at a heat-treatment temperature of 100° C. to obtain the perilla biomass extract.

### Embodiment 5

A carbon fixing and nitrogen retaining bio-organic fertilizer, prepared by the following method:
(1) Weigh corn stalks and polyvinyl alcohol resin at a mass ratio of 100:9. After crushing the corn stalks and polyvinyl alcohol resin, uniformly mix them with a solution containing potassium carbonate and potassium hydroxide, dry the mixture, place the dried mixture in a carbonization furnace, and conduct carbonization at 780° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.15. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.9:1.9, and the total mass of the strains in the compound microbial consortium constitutes 25% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.18:0.18, stir the mixture for 2 hours to obtain loaded biochar;
(5) Fully mix the loaded biochar, perilla biomass extract, and animal manure. The mass ratio of the loaded biochar, perilla biomass extract, and animal manure is 1:25:55. Stir the mixture for 30 minutes, and concentrate it to obtain the carbon fixing and nitrogen retaining bio-organic fertilizer.

The preparation method of the perilla biomass extract includes: adding 50 g of perilla to 1 L of water, stirring for 10 minutes, heat-treating the obtained juice for 3 hours at a heat-treatment temperature of 100° C. to obtain the perilla biomass extract.

### Embodiment 6

A carbon fixing and nitrogen retaining bio-organic fertilizer, prepared by the following method:
(1) Weigh corn stalks and polyvinyl alcohol resin at a mass ratio of 100:10. After crushing the corn stalks and polyvinyl alcohol resin, uniformly mix them with a solution containing potassium carbonate and potassium hydroxide, dry the mixture, place the dried mixture in a carbonization furnace, and conduct carbonization at 800° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.2. Stir the mixture for 4 hours, and grind it to obtain a hierarchical porous structure product;
(3) Mix the hierarchical porous structure product prepared in step (2) with a compound microbial consortium, stir the mixture for 2 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:2:2, and the total mass of the strains in the compound microbial consortium constitutes 30% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.2:0.2, stir the mixture for 2 hours to obtain loaded biochar;
(5) Fully mix the loaded biochar, perilla biomass extract, and animal manure. The mass ratio of the loaded biochar, perilla biomass extract, and animal manure is 1:25:50. Stir the mixture for 30 minutes, and concentrate it to obtain the carbon fixing and nitrogen retaining bio-organic fertilizer.

The preparation method of the perilla biomass extract includes: adding 60 g of perilla to 1 L of water, stirring for 10 minutes, heat-treating the obtained juice for 3 hours at a heat-treatment temperature of 110° C. to obtain the perilla biomass extract.

### Comparative Example 1

A carbon fixing and nitrogen retaining bio-organic fertilizer, prepared by the following method:
(1) Weigh corn stalks and polyvinyl alcohol resin at a mass ratio of 100:5. After crushing the corn stalks and polyvinyl alcohol resin, uniformly mix them with a solution containing, sodium carbonate and sodium hydroxide, dry the mixture, place the dried mixture in a carbonization furnace, and conduct carbonization at 750° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.08. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.5:1.5, and the total mass of the strains in the compound microbial consortium constitutes 15% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.1:0.1, stir the mixture for 1.5 hours to obtain loaded biochar;
(5) Fully mix the loaded biochar, perilla biomass extract, and animal manure. The mass ratio of the loaded biochar, perilla biomass extract, and animal manure is 1:40:60. Stir the mixture for 25 minutes, and concentrate it to obtain the carbon fixing and nitrogen retaining bio-organic fertilizer.

The preparation method of the perilla biomass extract includes: adding 30 g of perilla to 1 L of water, stirring for 10 minutes, heat-treating the obtained juice for 2.5 hours at a heat-treatment temperature of 90° C. to obtain the perilla biomass extract.

### Comparative Example 2

A carbon fixing and nitrogen retaining bio-organic fertilizer, prepared by the following method:
(1) Weigh corn stalks and polyvinyl alcohol resin at a mass ratio of 100:5. After crushing the corn stalks and polyvinyl alcohol resin, uniformly mix them with a solution containing potassium carbonate and potassium hydroxide, dry the mixture, place the dried mixture in a carbonization furnace, and conduct carbonization at 750° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.08. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.5:1.5, and the total mass of the strains in the compound microbial consortium constitutes 15% of the mass of the hierarchical porous structure product prepared in step (2);
(4) Immerse the modified biochar prepared in step (3) in a mixed solution containing copper sulfate and Mo-EDTA complex, the mass ratio of the modified biochar, copper sulfate, and Mo-EDTA complex is 1:0.1:0.1, stir the mixture for 1.5 hours to obtain loaded biochar;
(5) Fully mix the loaded biochar, perilla biomass extract, and animal manure. The mass ratio of the loaded biochar, perilla biomass extract, and animal manure is 1:40:60. Stir the mixture for 25 minutes, and concentrate it to obtain the carbon fixing and nitrogen retaining bio-organic fertilizer.

The preparation method of the perilla biomass extract includes: adding 30 g of perilla to 1 L of water, stirring for 10 minutes, heat-treating the obtained juice for 2.5 hours at a heat-treatment temperature of 90° C. to obtain the perilla biomass extract.

### Comparative Example 3

A carbon fixing and nitrogen retaining bio-organic fertilizer, prepared by the following preparation method:
(1) Weigh corn stalks and polyvinyl alcohol resin at a mass ratio of 100:5. After crushing the corn stalks and polyvinyl alcohol resin, uniformly mix them with a solution containing potassium carbonate and potassium hydroxide, dry the mixture, place the dried mixture in a carbonization furnace, and conduct carbonization at 750° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.08. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Frankia spp., and Aspergillus niger solutions, wherein the mass ratio of Azotobacter chroococcum, Frankia spp., and Aspergillus niger is 2:1.5:1.5, and the total mass of the strains in the compound microbial consortium constitutes 15% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.1:0.1, stir the mixture for 1.5 hours to obtain loaded biochar;
(5) Fully mix the loaded biochar, perilla biomass extract, and animal manure. The mass ratio of the loaded biochar, perilla biomass extract, and animal manure is 1:40:60. Stir the mixture for 25 minutes, and concentrate it to obtain the carbon fixing and nitrogen retaining bio-organic fertilizer.

The preparation method of the perilla biomass extract includes: adding 30 g of perilla to 1 L of water, stirring for 10 minutes, heat-treating the obtained juice for 2.5 hours at a heat-treatment temperature of 90° C. to obtain the perilla biomass extract.

### Comparative Example 4

A carbon fixing and nitrogen retaining bio-organic fertilizer, prepared by the following preparation method:
(1) Weigh corn stalks and polyvinyl alcohol resin at a mass ratio of 100:5. After crushing the corn stalks and polyvinyl alcohol resin, uniformly mix them with a solution containing potassium carbonate and potassium hydroxide, dry the mixture, place the dried mixture in a carbonization furnace, and conduct carbonization at 750° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.08. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Bacillus subtilis, and Aspergillus niger solutions, wherein the mass ratio of Azotobacter chroococcum, Bacillus subtilis, and Aspergillus niger is 2:1.5:1.5, and the total mass of the strains in the compound microbial consortium constitutes 15% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.1:0.1, stir the mixture for 1.5 hours to obtain loaded biochar;
(5) Fully mix the loaded biochar, perilla biomass extract, and animal manure. The mass ratio of the loaded biochar, perilla biomass extract, and animal manure is 1:40:60. Stir the mixture for 25 minutes, and concentrate it to obtain the carbon fixing and nitrogen retaining bio-organic fertilizer.

The preparation method of the perilla biomass extract includes: adding 30 g of perilla to 1 L of water, stirring for 10 minutes, heat-treating the obtained juice for 2.5 hours at a heat-treatment temperature of 90° C. to obtain the perilla biomass extract.

### Comparative Example 5

A carbon fixing and nitrogen retaining bio-organic fertilizer, prepared by the following preparation method:
(1) Weigh corn stalks and polyvinyl alcohol resin at a mass ratio of 100:5. After crushing the corn stalks and polyvinyl alcohol resin, uniformly mix them with a solution containing potassium carbonate and potassium hydroxide, dry the mixture, place the dried mixture in a carbonization furnace, and conduct carbonization at 750° C. under a nitrogen atmosphere to obtain activated biochar.
(2) Immerse the activated biochar prepared in step (1) in a mixed solution containing H₂O₂ and cobalt(II) ethylenediaminetetraacetate, the mass ratio of the activated biochar to cobalt(II) ethylenediaminetetraacetate in the mixed solution is 1:0.08. Stir the mixture for 3 hours, and grind it to obtain a hierarchical porous structure product;
(3) Mix the hierarchical porous structure product prepared in step (2) with a compound microbial consortium, stir the mixture for 1.5 hours to obtain modified biochar; the compound microbial consortium is obtained by mixing Azotobacter chroococcum, Pantoea ananatis, and Aspergillus niger solutions, wherein the mass ratio of Azotobacter chroococcum, Pantoea ananatis, and Aspergillus niger is 2:1.5:1.5, and the total mass of the strains in the compound microbial consortium constitutes 15% of the mass of the hierarchical porous structure product prepared in step (2);
(4) Immerse the modified biochar prepared in step (3) in a mixed solution containing tetraamminecopper(II) sulfate and Mo-EDTA complex, the mass ratio of the modified biochar, tetraamminecopper(II) sulfate, and Mo-EDTA complex is 1:0.1:0.1, stir the mixture for 1.5 hours to obtain loaded biochar;
(5) Fully mix the loaded biochar, nettle biomass extract, and animal manure. The mass ratio of the loaded biochar, nettle biomass extract, and animal manure is 1:40:60. Stir the mixture for 25 minutes, and concentrate it to obtain the carbon fixing and nitrogen retaining bio-organic fertilizer.

The preparation method of the nettle biomass extract includes: adding 30 g of nettle to 1 L of water, stirring for 10 minutes, heat-treating the obtained juice for 2.5 hours at a heat-treatment temperature of 90° C. to obtain the nettle biomass extract.

### Application Example

The carbon fixing and nitrogen retaining bio-organic fertilizers prepared in Embodiments 1-6 and Comparative Examples 1-5 were tested as follows:
(1) Test plant: Cherry tomato, specific variety is Millennium fruit.
(2) Test grouping: Flowerpots with a diameter of 15 cm and a height of 20 cm were selected. An appropriate amount of soil with basically the same physical and chemical characteristics was filled into each flowerpot. A hole of appropriate size was dug in the flowerpot, and cherry tomato seedlings with good growth of 12±cm were transplanted into the flowerpot. One cherry tomato seedling was transplanted into each flowerpot. 120 g of the carbon fixing and nitrogen retaining bio-organic fertilizer, mixed uniformly with an appropriate amount of soil, was filled into the flowerpot, and gently compacted. The carbon fixing and nitrogen retaining bio-organic fertilizers described in Embodiments 1-6 and Comparative Examples 1-5 were respectively applied, a total of 11 groups were set up, each group was set up with 5 parallels, and the average value was taken for each test result. No chemical fertilizers were added throughout the process. Keep the daytime temperature at about 25° C., the nighttime temperature at about 15° C., ensure 6-8 hours of light duration per day, keep the soil moist, and adjust the watering frequency according to the weather and soil moisture.

Analysis of cherry tomato plant growth: After the cherry tomatoes were harvested and picked, samples of cherry tomato plants in each group were collected, and the aboveground fresh weight, aboveground plant height, and plant stem diameter of each pot of cherry tomato plants were measured. The results are recorded in Table 1.

Measurement of aboveground fresh weight of cherry tomatoes: The plants were slowly rinsed with clean water, placed in a cool place to dry, and the aboveground fresh weight of the plants was measured under an electronic balance. The aboveground fresh weight of the plants in each group was recorded, and the average value was calculated.

Measurement of aboveground plant height of cherry tomatoes: The length from the root neck to the top was measured with a tape measure, which was the aboveground plant height. The aboveground plant height of each group was recorded, and the average value was calculated.

Measurement of plant stem diameter of cherry tomatoes: The plant diameter at 1 cm below the cotyledon was measured with a digital caliper, which was the plant stem diameter. The plant stem diameter of each group was recorded, and the average value was calculated.

TABLE 1
Effect of the carbon fixing and nitrogen retaining bio-organic fertilizer
of the present invention on the growth of cherry tomato plants

| | Fresh Weight | Plant Height | Plant Stem |
|---|---|---|---|
| Group | Aboveground/g | Aboveground/cm | Diameter /cm |
| Embodiment 1 | 171.64 | 104.00 | 1.14 |
| Embodiment 2 | 168.96 | 104.5 | 1.13 |
| Embodiment 3 | 172.11 | 105.25 | 1.14 |
| Embodiment 4 | 170.45 | 103.5 | 1.13 |
| Embodiment 5 | 169.43 | 104.00 | 1.14 |
| Embodiment 6 | 169.87 | 103.8 | 1.13 |
| Comparative | 158.34 | 101.00 | 1.11 |
| example 1 | | | |
| Comparative | 165.43 | 102.3 | 1.12 |
| example 2 | | | |
| Comparative | 160.24 | 101.4 | 1.11 |
| example 3 | | | |
| Comparative | 161.33 | 101.6 | 1.11 |
| example 4 | | | |
| Comparative | 159.56 | 102.50 | 1.12 |
| example 5 | | | |

It can be seen from the results in Table 1:

Comparing Embodiment 3 with Comparative Example 1, it can be seen that the present invention selects potassium hydroxide and potassium carbonate as activators to activate corn straw and polyvinyl alcohol resin rich in oxygen-containing functional groups to prepare activated biochar. Compared with using sodium carbonate and sodium hydroxide as activators, the joint activation of corn straw and polyvinyl alcohol resin by potassium hydroxide and potassium carbonate is more conducive to the loading of strains in the compound microbial consortium on the biochar, improves the utilization efficiency of strains, and further improves the carbon fixation and nitrogen retention capacity of the finally prepared organic fertilizer. The synergistic activation of the biomass system composed of straw and polyvinyl alcohol resin by potassium hydroxide and potassium carbonate can prepare biochar with a hierarchical pore structure, in which the proportion of macropores is large, ensuring the high loading rate of subsequent strains on the surface of the biochar. An appropriate amount of metal cobalt complex, metal molybdenum and copper complex, and strains are all loaded in the corresponding pore structures, further improving the pore utilization efficiency in the biochar. In the preparation process of the present invention, the complex microbial community is first loaded onto the biochar, and then the metal molybdenum and copper complexes are loaded. Since the molecular size of the metal molybdenum and copper complexes is much smaller than that of the strains in the compound microbial consortium, the complexes are combined with the active sites formed by each strain on the biochar, fully utilizing the active sites on the biochar, improving the utilization efficiency of the active sites in the biochar, and at the same time ensuring the loading efficiency of the strains in the compound microbial consortium. By using potassium carbonate and potassium hydroxide as activators, the plant growth is better than that using sodium carbonate and sodium hydroxide as activators, and the aboveground fresh weight, aboveground plant height, and plant stem diameter are all increased to a certain extent, indicating that the bio-organic fertilizer using potassium carbonate and potassium hydroxide as activators can better promote plant growth.

A comparison between Embodiment 3 and Comparative Example 2 demonstrates that the present invention employs cobalt (II) ethylenediaminetetraacetate, tetraamminecopper(II) sulfate, and molybdenum-EDTA complex as metal component precursors. Compared to inorganic metal salts, this approach ensures a low-salinity organic fertilizer, thereby avoiding high mortality rates of beneficial soil bacteria and promoting improved plant growth.

Comparing Embodiment 3 with Comparative Examples 3-4, it can be seen that the present invention employs Azotobacter chroococcum, Pantoea ananatis, and Aspergillus niger as the compound microbial consortium. In addition to the mutual cooperation between the free-living nitrogen-fixing and the degrading microbes, and the mutual provision of energy substances within the microbes, the intermediate product of a certain microbial species of this solution may be more conducive to the degradation or nitrogen fixation of other microbial species. Compared with the compound microbial consortium obtained by other combinations, the compound microbial consortium recorded in the present invention can endow the organic fertilizer with better fertility, accelerate the nitrogen fixation process, and improve the nitrogen fixation efficiency. Therefore, the interaction within the compound microbial consortiums selected in the present invention better promotes the nutrient utilization rate in the organic fertilizer and provides more abundant nutrients for plant growth.

Comparing Embodiment 3 with Comparative Example 5, it can be seen that the perilla biomass extract obtained by using perilla as the raw material for the biomass extract in the present invention can better promote plant growth compared with other plant biomass extracts.

Analysis of soil physical and chemical indexes: After the cherry tomatoes were harvested, 200 g of soil was collected from each flowerpot, and the soil water content, pH value, organic matter, and nitrogen content were measured. The average value of each group was measured, and the results are recorded in Table 2.

Soil water content determination method: Collect 20 g of experimental soil samples, put them into a dry container, weigh to get m1 grams, put the container with the collected soil samples into an oven, bake until the weight no longer changes, take out and weigh to get m2 grams, and the water content can be calculated.

The Soil water content calculation formula:

$$W = ( m 1 - m 2 ) / ( m 2 - m ) \times 100 \% ;$$

W—soil water content;
m—container (g);
m1—container and wet soil sample weight (g);
m2—container and dry soil sample weight (g).

Soil pH determination method: Take 10 g of soil samples, air-dry the soil samples, grind them to get through a 20-mesh sieve, and measure the soil pH with a pH meter (Leici PHS-25) at a water-soil ratio of 2.5:1.

Soil organic matter content determination method: Take 0.5 g of the dried soil sample passing through a 100-mesh sieve, put it into a 500 mL conical flask, add 10 mL of 1 mol/L K₂Cr₂O₇ aqueous solution, and gently shake to disperse the soil particles; add 10 mL of concentrated sulfuric acid to the conical flask, shake well, and let stand for 30 minutes; then add 200 mL of water and 4 drops of o-phenanthroline indicator to the conical flask, and finally titrate with 0.5 mol/L FeSO₄ standard solution to the end point, while doing a blank determination and recording the consumption of ferrous iron. The soil organic matter is calculated as follows:

$$Soil organic matter g / kg = M ( {V}_{0} - V ) \times 0.0057 \times 1.4 \times 1000 / W$$

M—molar concentration of the standard ferrous solution;
V₀—blank titration ferrous solution consumption, mL;
V—sample titration ferrous solution consumption, mL;
W—dried soil weight, g.

Soil nitrogen content determination method: See the Agricultural Standard of the People's Republic of China—Organic Fertilizer (NY525-2012).

TABLE 2
Effects of the carbon fixing and nitrogen retaining bio-organic fertilizer
of the invention on the physical and chemical indexes of soil.

| | Soil Water | pH of | Soil organic | Soil Nitrogen |
|---|---|---|---|---|
| Group | Content % | Soil | matter g/kg | content g/kg |
| Embodiment | 27 | 7.2 | 22.31 | 48.19 |
| 1 | | | | |
| Embodiment | 25 | 7.2 | 23.43 | 47.81 |
| 2 | | | | |
| Embodiment | 25 | 7.3 | 23.45 | 48.65 |
| 3 | | | | |
| Embodiment | 22 | 7.5 | 22.87 | 47.77 |
| 4 | | | | |
| Embodiment | 23 | 7.4 | 22.66 | 47.64 |
| 5 | | | | |
| Embodiment | 24 | 7.4 | 22.79 | 48.21 |
| 6 | | | | |
| Comparative | 20 | 7.8 | 19.02 | 42.11 |
| example 1 | | | | |
| Comparative | 18 | 7.7 | 19.56 | 45.51 |
| example 2 | | | | |
| Comparative | 16 | 7.8 | 20.67 | 41.17 |
| example 3 | | | | |
| Comparative | 19 | 7.9 | 19.34 | 40.55 |
| example 4 | | | | |
| Comparative | 19 | 8.1 | 20.12 | 44.67 |
| example 5 | | | | |

It can be seen from Table 2:

Comparing Embodiment 3 with Comparative Example 1, it can be seen that the present invention selects potassium hydroxide and potassium carbonate as activators to activate corn straw and polyvinyl alcohol resin rich in oxygen-containing functional groups to prepare activated biochar. Compared with using sodium carbonate and sodium hydroxide as activators, the soil organic matter and nitrogen content applied with the organic fertilizer are higher, that is, the carbon fixation and nitrogen retention capacity of the bio-organic fertilizer is improved.

Comparing Embodiment 3 with Comparative Example 2, it can be seen that the present invention uses cobalt(II) ethylenediaminetetraacetate, tetraamminecopper(II) sulfate, and Mo-EDTA complex as the precursors of the metal components. Compared with the metal inorganic salt components, it can further improve the soil properties, thereby playing a better role in promoting plant growth.

Comparing Embodiment 3 with Comparative Examples 3-4, it can be seen that the present invention uses Azotobacter chroococcum, Pantoea ananatis, and Aspergillus niger as the compound microbial consortium. In addition to the mutual cooperation between the free-living nitrogen-fixing microbes and the degrading microbes, and the mutual provision of energy substances within the microbial species, the intermediate product of a certain microbial species may be more conducive to the degradation or nitrogen fixation of other species. Compared with the compound microbial consortium obtained by other combinations, the compound microbial consortium recorded in the present invention can endow the organic fertilizer with better fertility, accelerate the nitrogen fixation process, and improve the nitrogen fixation efficiency. Therefore, the interaction within the compound microbial consortiums selected in the present invention increases the water conservation of the soil, improves the physical and chemical properties of the soil, makes the soil more loose and fertile, and is therefore more conducive to plant growth.

Comparing Embodiment 3 with Comparative Example 5, it can be seen that the present invention uses perilla as the raw material for the biomass extract. As perilla has a high nitrogen content, compared with other plants, the nitrogen has a higher nitrogen recovery rate through the preparation of the biomass extract, and then be introduced into the soil through the organic fertilizer of the invention, which can increase the nitrogen content in the soil and better promote plant growth.

The organic fertilizer in the present invention can increase the soil organic matter and nitrogen content, adjust the pH value, the compound microbial consortium can promote the decomposition of organic matter and the availability of nutrients, promote soil improvement, and be conducive to the improvement of soil productivity. At the same time, the organic fertilizer can significantly improve soil enzyme activity, promote the improvement of soil fertility, and achieve the role of soil conditioning.

The applicant declares that the present invention illustrates the technical solution of the present invention through the above embodiments, but the present invention is not limited to the above embodiments, that is, it does not mean that the present invention must rely on the above embodiments to implement. Those skilled in the art should understand that any improvement to the present invention, equivalent replacements for the raw materials of the present invention product, addition of auxiliary components, selection of specific methods, etc., fall within the protection scope and disclosure scope of the present invention.

The above content is only an example and illustration of the present invention. Those skilled in the art can make various modifications, supplements, or similar replacements to the described specific embodiments without departing from the invention or exceeding the scope defined by the claims, and all should belong to the protection scope of the present invention.

In addition, it should be noted that the various specific technical features described in the above specific embodiments can be combined in any suitable manner without contradiction. In order to avoid unnecessary repetition, the present invention does not separately describe other possible combination manners.

1. A method for preparing a Carbon-Fixing and nitrogen-retaining bio-organic fertilizer, comprising the following steps:
(1) crushed corn stalks and polyvinyl alcohol resin with a solution containing potassium carbonate and potassium hydroxide are mixed, dried and carbonized in a nitrogen atmosphere at 700-800° C. in a carbonization furnace, to obtain activated biochar;
(2) The activated bio-charcoal is immersed in a mixture of H₂O₂ and Cobalt(II) Ethylenediaminetetraacetate (Co-EDTA); stir the mixture for 2-4 hours, grind it to obtain a hierarchical porous structure product;
(3) The hierarchical porous product prepared by step 2 is mixed with a composite microbial consortium and stirred for 1-2 hours to yield modified biochar; the composite microbial consortium comprises Azotobacter chroococcum, Pantoea ananatis, and Aspergillus niger;
(4) The modified bio-charcoal obtained by step 3 is immersed in a solution of tetraamminecopper(II) sulfate and Mo-EDTA complex, and stirred for 1-2 hours to obtain loaded biochar;
(5) The loaded biochar is fully mixed with perilla biomass extract and animal manure, and stirred for 20-30 minutes, concentrated to obtain the final carbon-fixing and nitrogen-retaining bio-organic fertilizer;
wherein the mass ratio of corn stalks to polyvinyl alcohol resin in step (1) is 100:(1-10), and the carbonization temperature is 700-800° C.;
wherein the perilla biomass extract is prepared by mixing perilla with water (5-60 g/L), stirring for 10 minutes, and heat-treating the liquid at 80-120° C. for 2-3 hours.

2. (canceled)

3. The method of claim 1, wherein the mass ratio of activated biochar to Co-EDTA in step (2) is 1:(0.01-0.2), with a stirring time of 2 hours.

4. The method of claim 1, wherein the mass ratio of A. chroococcum:P. ananatis:A. niger in step (3) is 2:(1-2):(1-2), and the total mass of the compound microbial consortium constitutes 2-30% of the porous product by weight.

5. (canceled)

6. The method according to claim 1, wherein the juice is prepared by adding 5-60 grams of perilla to 1 liter of water.

7. The method of claim 1, wherein the mass ratio of the modified biochar, tetraamminecopper(II) sulfate, and Mo-EDTA complex in step (4) is 1:(0.05-0.2):(0.05-0.2).

8. The method according to claim 1, wherein the mass ratio of the loaded biochar, perilla biomass extract, and animal manure in step (5) is 1:(10-100):(10-100).

9. A Carbon-Fixing and nitrogen-retaining bio-organic fertilizer prepared by the method according to claim 1.
